(19) United States
(12) Patent Application Publication
(10) Pub. No.: US 2025/0321958 A1
(43) Pub. Date: Oct. 16, 2025

(54) INFORMATION PROCESSING APPARATUS, ANSWER GENERATION METHOD, AND RECORDING MEDIUM

(71) Applicant: NEC Corporation, Tokyo (JP)

(72) Inventor: Keigo HAYATA, Tokyo (JP)

(73) Assignee: NEC Corporation, Tokyo (JP)

(21) Appl. No.: 19/173,924

(22) Filed: Apr. 9, 2025

(30) Foreign Application Priority Data
Apr. 15, 2024 (JP) 2024-065532

(51) Int. Cl. G06F 16/242

(52) U.S. Cl. CPC G06F 16/243

(57) ABSTRACT

Accuracy of an answer to a question is improved. An information processing apparatus includes: a query generation section that uses at least one generation model, which has been generated by being trained by machine learning so as to be able to generate a search query that is in accordance with an input question, to generate a search query that is for retrieving information related to a target question; and an answer generation section that uses information detected by search with use of the search query to generate an answer to the target question. This information processing apparatus makes it easy to generate an answer that is optimized for a specific application.

This Nonprovisional application claims priority under 35 U.S.C. § 119 on Patent Application No. 2024-065532 filed in Japan on Apr. 15, 2024, the entire contents of which are hereby incorporated by reference.

### TECHNICAL FIELD

The present disclosure relates to an information processing apparatus, an answer generation method, and a recording medium.

### BACKGROUND ART

A technique for using, for example, a large language model to automatically generate an answer to a question is known. For example, Patent Literature 1 below indicates that a prompt for input into a large language model is generated by adding reference information to an input question sentence. By adding reference information to a question sentence, it is possible to cause a large language model to generate an answer sentence that considers reference information.

### CITATION LIST

### Patent Literature

### Patent Literature 1

Japanese Patent No. 7325152

### SUMMARY OF INVENTION

### Technical Problem

In a sentence generation method disclosed in Patent Literature 1, a feature vector of a sentence is calculated from the input question sentence in order to acquire the foregoing reference information. A sentence with which a feature vector similar to the calculated feature vector is associated is detected from among a plurality of sentences recorded in a sentence database, and the detected sentence is used as the reference information.

The above-described sentence generation method has room for improvement in that accuracy of an answer to be generated is affected by a question sentence to be input. For example, in the sentence generation method disclosed in Patent Literature 1, in a case where the input question sentence clearly and briefly indicates what a questioner wishes to ask, it is considered that an appropriate feature vector is calculated, and appropriate reference information is acquired. In contrast, in a case where the input question sentence is unclear, insufficient in explanation, or redundant, the calculated feature vector is highly likely not to reflect an intention of the questioner. In this case, it is considered that reference information which is irrelevant to the intention of the questioner is acquired, and accuracy of an answer deteriorates.

The present disclosure has been made in view of the above problems, and an example object thereof is to provide a technique that makes it possible to improve accuracy of an answer to a question.

### Solution to Problem

An information processing apparatus in accordance with an example aspect of the present disclosure includes at least one processor, the at least one processor carrying out: a query generation process for using at least one generation model, which has been generated by being trained by machine learning so as to be able to generate a search query that is in accordance with an input question, to generate a search query that is for retrieving information related to a target question to which an answer is to be generated; and an answer generation process for using information detected by search with use of the search query to generate the answer to the target question.

An answer generation method in accordance with an example aspect of the present disclosure includes: a query generation step of using at least one generation model, which has been generated by being trained by machine learning so as to be able to generate a search query that is in accordance with an input question, to generate a search query that is for retrieving information related to a target question to which an answer is to be generated; and an answer generation step of using information detected by search with use of the search query to generate the answer to the target question, the query generation step and the answer generation step each being carried out by at least one processor.

A recording medium in accordance with an example aspect of the present disclosure is a non-transitory computer-readable recording medium recording therein an answer generation program for causing a computer to carry out: a query generation process for using at least one generation model, which has been generated by being trained by machine learning so as to be able to generate a search query that is in accordance with an input question, to generate a search query that is for retrieving information related to a target question to which an answer is to be generated; and an answer generation process for using information detected by search with use of the search query to generate the answer to the target question.

### Advantageous Effects of Invention

An example aspect of the present disclosure brings about an example advantage of making it possible to improve accuracy of an answer to a question.

### BRIEF DESCRIPTION OF DRAWINGS

FIG. 1 is a block diagram illustrating a configuration of an information processing apparatus in accordance with the present disclosure.

FIG. 2 is a flowchart showing a flow of an answer generation method in accordance with the present disclosure.

FIG. 3 is a diagram illustrating a configuration of a response system in accordance with the present disclosure.

FIG. 4 is a block diagram illustrating a configuration of an information processing apparatus that is included in the response system illustrated in FIG. 3.

FIG. 5 is a diagram showing an example template that is used to generate a prompt.

FIG. 6 is a flowchart showing an example process that is carried out by the information processing apparatus illustrated in FIG. 4.

FIG. 7 is a block diagram illustrating a configuration of a computer that functions as the information processing apparatus in accordance with the present disclosure.

### EXAMPLE EMBODIMENTS

The following description will discuss example embodiments of the present invention. Note, however, that the present invention is not limited to the example embodiments described below, but can be altered in various ways by a skilled person in the art within the scope of the claims. For example, the present invention can also encompass, in its scope, any example embodiment derived by appropriately combining techniques (some or all of products or processes) employed in the example embodiments described below. Further, the present invention can also encompass, in its scope, any example embodiment derived by appropriately omitting some of the techniques employed in the example embodiments described below. Furthermore, effects mentioned in the example embodiments described below are example effects expected in the example embodiments described below, and are not intended to define an extension of the present invention. That is, the present invention can also encompass, in its scope, any example embodiment that does not bring about any of the effects mentioned in the example embodiments described below.

### First Example Embodiment

The following description will discuss a first example embodiment, which is an example embodiment of the present invention, in detail with reference to the drawings. The present example embodiment is a basic form of example embodiments described later. Note that the scope of application of techniques which are employed in the present example embodiment is not limited to the present example embodiment. That is, the techniques which are employed in the present example embodiment can be employed also in the other example embodiments included in the present disclosure, provided that no particular technical problem occurs. Moreover, techniques which are indicated in the drawings referred to for describing the present example embodiment can be employed also in the other example embodiments included in the present disclosure, provided that no particular technical problem occurs.

### (Configuration of Information Processing Apparatus 1)

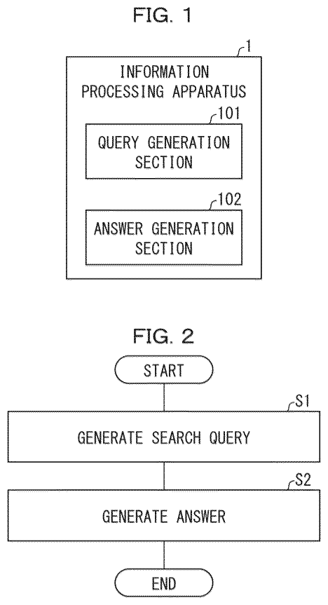

A configuration of an information processing apparatus 1 in accordance with the present example embodiment will be described with reference to FIG. 1. FIG. 1 is a block diagram illustrating the configuration of the information processing apparatus 1. The information processing apparatus 1 includes a query generation section 101 and an answer generation section 102 as illustrated in FIG. 1.

The query generation section 101 uses at least one generation model, which has been generated by being trained by machine learning so as to be able to generate a search query that is in accordance with an input question, to generate a search query that is for retrieving information related to a target question to which an answer is to be generated.

The at least one generation model is a trained model that has been generated by being trained by machine learning so as to be able to generate a search query which is in accordance with an input question and which is for retrieving information related to the input question. The generation model may be a general-purpose language model (a model that has been generated by machine learning of an arrangement of, for example, words or sentences, which are components of natural language). The generation model may alternatively be a model that is specialized in generation of a search query (a model that has been generated by machine learning of a correspondence relationship between a question and a search query corresponding to the question). The generation model may alternatively be a model that has been generated by fine-tuning a general-purpose language model with use of training data in which a question and a search query corresponding to the question are associated with each other.

The answer generation section 102 uses information detected by search with use of the search query generated by the query generation section 101 to generate an answer to the target question. Note that “search with use of the search query generated by the query generation section 101” includes not only search carried out by using the search query as it is but also search carried out with use of information generated with use of the search query (e.g., a feature vector representing a feature of the search query). Note also that search may be carried out by the information processing apparatus 1 or may be carried out by another apparatus. In the latter case, the query generation section 101 transmits the generated search query to the another apparatus and causes the another apparatus to carry out search, and the answer generation section 102 acquires a search result from the another apparatus and generates the answer.

A method in which the answer is generated by the answer generation section 102 is not particularly limited. For example, the answer generation section 102 may cause a language model that has been generated by machine learning of natural language to use (i) information detected by search with use of the search query generated by the query generation section 101 and (ii) the target question as input to generate the answer. In a case where a generation model that is used to generate a search query is a language model, the answer generation section 102 may cause the generation model to generate the answer. For example, a plurality of templates that are in accordance with content of the target question may be prepared in advance. In this case, the answer generation section 102 can generate the answer by entering information detected by search into a template that is in accordance with content of the target question.

As described above, a configuration is employed such that the information processing apparatus 1 in accordance with the present example embodiment includes: the query generation section 101 that uses at least one generation model, which has been generated by being trained by machine learning so as to be able to generate a search query that is in accordance with an input question, to generate a search query that is for retrieving information related to a target question to which an answer is to be generated; and the answer generation section 102 that uses information detected by search with use of the search query, which is generated by the query generation section 101, to generate the answer to the target question.

According to the above configuration, instead of using information obtained by using the target question as it is for search, information detected by search with use of the search query generated by the generation model is used to generate the answer. With this, for example, even in a case where the target question is unclear, insufficient in explanation, or redundant, a search query that is in accordance with an intention of a questioner makes it possible to detect information that is in accordance with the intention of the questioner, and generate an answer that is in accordance with the intention of the questioner. Thus, the information processing apparatus 1 brings about an effect of making it possible to improve accuracy of an answer to a question.

Further, the information processing apparatus 1 makes it easy to generate an answer that is optimized for a specific application. In a case where the information processing apparatus 1 is caused to generate the answer that is optimized for a specific application, a database in which information that is in accordance with the specific application is recorded need only be used as a search target. For example, by using, as a search target, a database in which a user manual for a product or service is recorded, it is possible to generate an answer that is in accordance with the user manual. Further, for example, a database in which information about a remedy in case of occurrence of illness or injury is recorded may be used as the search target. This makes it possible to generate an accurate answer to a question about the remedy in case of occurrence of illness or injury. The information processing apparatus 1 thus can also be used in a healthcare application.

### (Answer Generation Program)

The foregoing functions of the information processing apparatus 1 can also be realized by a program. An answer generation program in accordance with the present example embodiment causes a computer to function as: a query generation means for using at least one generation model, which has been generated by being trained by machine learning so as to be able to generate a search query that is in accordance with an input question, to generate a search query that is for retrieving information related to a target question to which an answer is to be generated; and an answer generation means for using information detected by search with use of the search query, which is generated by the query generation means, to generate the answer to the target question. The answer generation program makes it possible to improve accuracy of an answer to a question.

### (Flow of Answer Generation Method)

A flow of an answer generation method in accordance with the present example embodiment will be described with reference to FIG. 2. FIG. 2 is a flowchart showing the flow of the answer generation method. Note that steps of the answer generation method each may be carried out by a processor included in the information processing apparatus 1 or by a processor included in another apparatus. Alternatively, the steps may be carried out by processors provided in respective different apparatuses.

In S1 (a query generation process), at least one generation model, which has been generated by being trained by machine learning so as to be able to generate a search query that is in accordance with an input question, is used to generate a search query that is for retrieving information related to a target question to which an answer is to be generated.

In S2 (an answer generation process), at least one processor uses information detected by search with use of the search query generated in S1 to generate the answer to the target question.

As described above, a configuration is employed such that an answer generation method in accordance with the present example embodiment includes: a query generation process for using at least one generation model, which has been generated by being trained by machine learning so as to be able to generate a search query that is in accordance with an input question, to generate a search query that is for retrieving information related to a target question to which an answer is to be generated; and an answer generation process for using information detected by search with use of the search query, which has been generated in the query generation process, to generate the answer to the target question, the query generation process and the answer generation process each being carried out by at least one processor. Thus, the answer generation method in accordance with the present example embodiment makes it possible to improve accuracy of an answer to a question.

### Second Example Embodiment

A second example embodiment, which is an example embodiment of the present invention, will be described in detail with reference to the drawings. Constituent elements having functions identical to those of the respective constituent elements described in the foregoing example embodiment are given respective identical reference numerals, and a description thereof is omitted as appropriate. Note that the scope of application of techniques which are employed in the present example embodiment is not limited to the present example embodiment. That is, the techniques which are employed in the present example embodiment can be employed also in the other example embodiments included in the present disclosure, provided that no particular technical problem occurs. Moreover, techniques which are indicated in the drawings referred to for describing the present example embodiment can be employed also in the other example embodiments included in the present disclosure, provided that no particular technical problem occurs.

### (Configuration of Response System 100A)

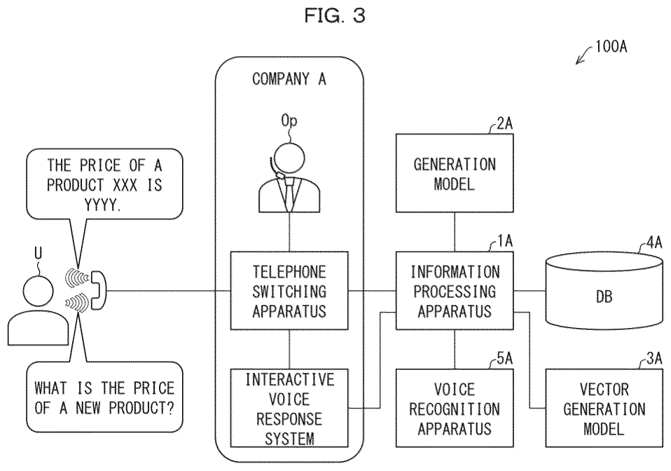

A configuration of a response system 100A in accordance with the present example embodiment will be described with reference to FIG. 3. FIG. 3 is a diagram illustrating the configuration of the response system 100A. The response system 100A is a system that has a function to automatically respond to a question by telephone from a user thereof. The response system 100A includes an information processing apparatus 1A, a generation model 2A, a vector generation model 3A, a database (DB) 4A, and a voice recognition apparatus 5A as illustrated in FIG. 3.

The information processing apparatus 1A is an apparatus that has a function to generate an answer to a question. Although details will be described below, the information processing apparatus 1A uses the generation model 2A to generate a search query that is for retrieving information related to a target question to which an answer is to be generated. The information processing apparatus 1A uses the generated search query to search the DB 4A, and uses data detected by searching the DB 4A to generate an answer to the target question.

As in the case of the generation model described in the first example embodiment, the generation model 2A is a trained model that has been generated by being trained by machine learning so as to be able to generate a search query which is in accordance with an input question and which is for retrieving information related to the input question. The present example embodiment discusses an example in which the generation model 2A is a general-purpose language model (i.e., a model that has been generated by machine learning of an arrangement of, for example, words or sentences, which are components of natural language). Note that the generation model 2A may be stored in the information processing apparatus 1A, or may be stored in another apparatus. In the latter case, the information processing apparatus 1A instructs an apparatus that stores the generation model 2A to generate a search query, and acquires the generated search query from the apparatus. Similarly, the vector generation model 3A may be stored in the information processing apparatus 1A, or may be stored in another apparatus.

The vector generation model 3A is a trained model that has been generated by being trained by machine learning so as to be able to generate a feature vector representing a feature of input data. The vector generation model 3A is used to generate a feature vector of the foregoing search query. Thus, in a case where a search query described in natural language is used, a model that has been generated by being trained by machine learning so as to be able to generate a feature vector representing a feature of an input sentence of natural language is used as the vector generation model 3A. The feature vector of the search query which feature vector is generated by the vector generation model 3A is used for search.

The DB 4A is a database that is to be searched by the foregoing search query. As described earlier, the feature vector of the search query is used for search. Thus, also with each piece of information recorded in the DB 4A, a feature vector of the information is associated in advance.

Note here that, as described in the first example embodiment, content of an answer to be generated is affected by what type of information is recorded in a database to be searched. As in the example of FIG. 3, in a case where the information processing apparatus 1A is caused to generate an answer to a question about a product that is handled by a company, the DB 4A in which information about the product that is handled by the company is recorded need only be used. In this case, for example, a document such as a product manual in which the above information is described may be divided into a plurality of chunks, and feature vectors of the chunks may be associated with the respective chunks. This makes it possible to detect, as the information related to the input question, a chunk (a part of the above document) with which a feature vector similar to the feature vector of the search query is associated. Note that the document may be divided into chunks by any method. For example, a target document may be mechanically divided into chunks for each predetermined number of characters, or may be divided into chunks in units of chapters, clauses, paragraphs, or sentences included in the target document. The DB 4A may store a collection of frequently asked questions and answers for a target product. In this case, feature vectors of frequently asked questions and answers need only be associated with the respective frequently asked questions and answers.

The voice recognition apparatus 5A is an apparatus that converts voice data into text data. In the response system 100A, the information processing apparatus 1A acquires voice data obtained by converting voice of a user into data, and transmits the voice data to the voice recognition apparatus 5A. The voice recognition apparatus 5A converts the received voice data to text data and returns the text data to the information processing apparatus 1A. Note that the information processing apparatus 1A may be provided with a voice recognition function. In this case, the voice recognition apparatus 5A is omitted.

In the example of FIG. 3, a function of an existing interactive voice response system provided in a company A is extended by the response system 100A. The response system 100A thus can be easily incorporated in the existing interactive voice response system. Incorporating the response system 100A in the existing interactive voice response system makes it possible to realize highly accurate automatic response.

Note here that FIG. 3 illustrates an example in which a user U of the response system 100A calls the company A to inquire about the price of a new product. In this example, voice data of a question asked by the user U (specifically, an inquiry about the price of the new product) is transmitted to the information processing apparatus 1A via a telephone switching apparatus of the company A.

First, the information processing apparatus 1A uses the voice recognition apparatus 5A to convert the voice data into text data. Next, the information processing apparatus 1A uses the generation model 2A to generate a search query for retrieving information related to the question asked by the user U. Subsequently, the information processing apparatus 1A causes the vector generation model 3A to generate a feature vector of the generated search query. Then, by using the generated feature vector to search the DB 4A, the information processing apparatus 1A detects the information related to the question asked by the user U.

The information processing apparatus 1A uses the information detected by search of the DB 4A to generate an answer to the question asked by the user U. Specifically, the information processing apparatus 1A inputs, into the generation model 2A, the question asked by the user U and the information obtained by search, and causes the generation model 2A to generate the answer. The generated answer is converted into voice by the interactive voice response system and output to the user U via the telephone switching apparatus. Note that the information processing apparatus 1A may also carry out conversion into voice.

In the example of FIG. 3, an answer “the price of a product XXX is YYYY” is output to the user U. The response system 100A thus makes it possible to present, to a question that does not specify the name of a product and that lacks clarity, such as a question “What is the price of a new product?” asked by the user U, the product price that is in accordance with an intention of the user U. Further, also in a case where the question asked by the user U is insufficient in explanation or redundant (for example, to a question such as “I'm thinking of buying, well, that new one which was recently released, and I have decided to check the price thereof first of all.”), the response system 100A makes it possible to present an answer that is in accordance with the intention of the user U. As described above, according to the response system 100A, even in a case where the question asked by the user U is unclear, insufficient in explanation, or redundant, it is possible to present the answer that is in accordance with the intention of the user U.

Although details will be described later, the response system 100A makes it possible to switch between a response by the information processing apparatus 1A and a response by an operator Op. This makes it possible to carry out an appropriate response even in a situation where the response by the information processing apparatus 1A is difficult.

### (Configuration of Information Processing Apparatus 1A)

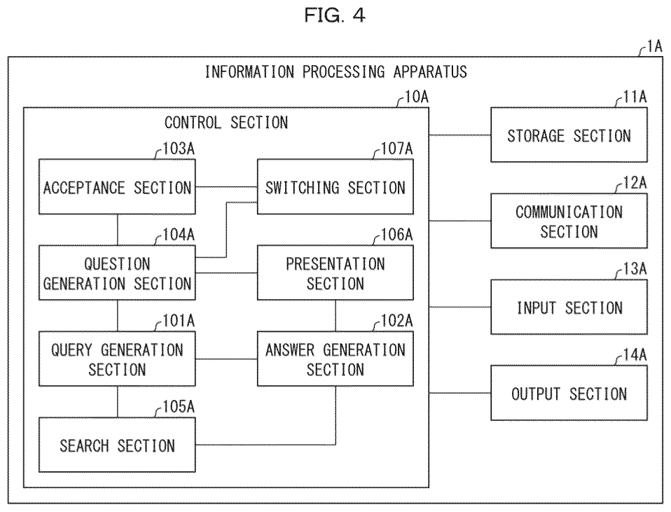

A configuration of an information processing apparatus 1A in accordance with the present example embodiment will be described with reference to FIG. 4. FIG. 4 is a block diagram illustrating the configuration of the information processing apparatus 1A. As illustrated in FIG. 4, the information processing apparatus 1A includes a control section 10A that collectively controls sections of the information processing apparatus 1A and a storage section 11A that stores various kinds of data used by the information processing apparatus 1A. The information processing apparatus 1A further includes a communication section 12A that allows the information processing apparatus 1A to communicate with another apparatus, an input section 13A that accepts input to the information processing apparatus 1A, and an output section 14A that allows the information processing apparatus 1A to output data. The control section 10A includes a query generation section 101A, an answer generation section 102A, an acceptance section 103A, a question generation section 104A, a search section 105A, a presentation section 106A, and a switching section 107A. Note that the switching section 107A will be described in the “Switching to handling by operator” section described later.

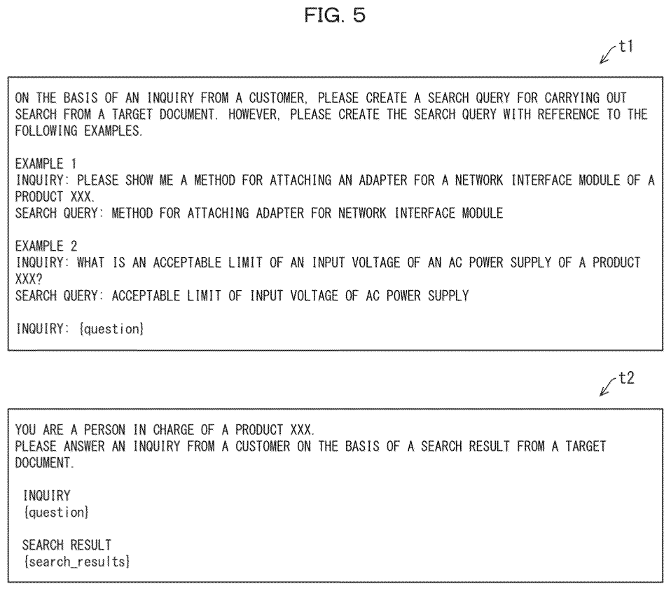

As in the case of the query generation section 101 of the first example embodiment, the query generation section 101A uses the generation model 2A, which has been generated by being trained by machine learning so as to be able to generate a search query that is in accordance with an input question, to generate a search query that is for retrieving information related to a target question to which an answer is to be generated. More specifically, the query generation section 101A uses the target question to generate a prompt that instructs generation of the search query, and generates the search query by inputting the generated prompt into the generation model 2A. Note that details of the prompt generated by the query generation section 101A will be described later with reference to FIG. 5.

As in the case of the answer generation section 102 of the first example embodiment, the answer generation section 102A uses information detected by search with use of the search query generated by the query generation section 101A to generate an answer to the target question.

Note here that, as described earlier, in the present example embodiment, a language model that has been generated by machine learning of natural language is used as the generation model 2A. In this case, the answer generation section 102A may use the generation model 2A to generate the answer to the target question. This brings about not only the effect brought about by the information processing apparatus 1 but also an effect of making it possible to use a single generation model 2A to generate both the search query and the answer.

In order to generate the answer, first, the answer generation section 102A uses the target question and information detected by search with use of the search query generated by the query generation section 101A to generate a prompt that instructs generation of the answer to the target question. Then, the answer generation section 102A generates the answer by inputting the generated prompt into the generation model 2A. Note that details of the prompt generated by the answer generation section 102A will be described later with reference to FIG. 5.

The acceptance section 103A accepts input of various kinds of information. For example, the acceptance section 103A accepts input of a question from a questioner. Further, for example, the acceptance section 103A accepts the answer that has been generated by the answer generation section 102A and feedback that is given by the questioner to an alternative question (described later). A feedback method is not particularly limited. For example, the acceptance section 103A may accept feedback by voice or may accept feedback by input of text or input by a predetermined operation.

The question generation section 104A generates the alternative question by paraphrasing a question that has been input by the questioner. The alternative question generated by the question generation section 104A is presented to the questioner by the presentation section 106A. The acceptance section 103A accepts feedback given by the questioner to the presented alternative question. In a case where the feedback given to the alternative question is affirmative in content, the answer generation section 102A generates the answer with use of information detected by search with use of a search query that is for retrieving information related to the alternative question. In the alternative question obtained by paraphrasing the question that has been input by the questioner, an intention of the questioner can be more accurately reflected than in the original question. Thus, the information processing apparatus 1A brings about not only the effect brought about by the information processing apparatus 1 but also an effect of making it possible to further improve accuracy of an answer to be generated. Note that the search query that is for retrieving information related to the alternative question need only be generated by the query generation section 101A. For example, the query generation section 101A may input the alternative question into the generation model 2A and cause the generation model 2A to generate the search query that is for retrieving information related to the alternative question. Alternatively, for example, the query generation section 101A may input, into the generation model 2A, information for use in generation of the alternative question (for example, a summary (described later) and/or a question on which the alternative question is based) and cause the generation model 2A to generate the search query that is for retrieving information related to the alternative question.

Note that paraphrasing means rewording. A method for paraphrasing is not particularly limited, but it is preferable to apply a method such that the alternative question in which the intention of the questioner is reflected as accurately as possible is generated. For example, the question generation section 104A may generate a summary of a question that has been input by the questioner, and use the generated summary to generate the alternative question. The summary need only be generated by the generation model 2A or another language model. Further, the question generation section 104A may generate the alternative question with use of not only the generated summary but also a search result obtained by searching the DB 4A for the summary. Alternatively, for example, the question generation section 104A may generate the alternative question by generating a prompt that includes the question which has been input by the questioner and that instructs generation of a question obtained by rewording, in an easy-to-understand manner, the question which has been input by the questioner, and inputting the prompt into a language model such as the generation model 2A. Further, the question generation section 104A may cause the prompt to include relevant information (for example, age, gender, occupation, a place of residence, a hometown, language used, a knowledge level, a question input in the past, an answer generated to the question, etc.) related to the questioner or a presentation target person to whom an answer to a question is to be presented. This makes it possible to generate a more accurate alternative question.

The search section 105A uses search with use of the search query generated by the query generation section 101A to detect information related to the target question. More specifically, the search section 105A inputs, into the vector generation model 3A, the search query generated by the query generation section 101A, and causes the vector generation model 3A to generate a feature vector of the search query. Then, the search section 105A uses the generated feature vector to search the DB 4A. As described earlier, with each piece of information recorded in the DB 4A, a feature vector of the information is associated in advance. Thus, the search section 105A can detect, as information related to the target question, information with which a feature vector similar to the generated feature vector is associated. Note that a degree of similarity between feature vectors can be calculated with use of, for example, a well-known technique. For example, the search section 105A may calculate a degree of cosine similarity between feature vectors. The search section 105A may detect all information with which a feature vector whose degree of similarity to the generated feature vector is not less than a threshold is associated, or may detect each piece of information associated with a predetermined number of feature vectors whose degree of similarity to the generated feature vector is ranked high.

The presentation section 106A presents various kinds of information. For example, the presentation section 106A presents an answer, which is generated by the answer generation section 102A, to a presentation target person to whom the answer is to be presented. Further, as described earlier, the presentation section 106A presents the alternative question to the questioner. In the present example embodiment, the questioner and the presentation target person to whom the answer is to be presented are identical (for example, the user U in the example of FIG. 3), and the answer is presented in the form of voice output. Thus, the presentation section 106A presents the answer to the questioner in the form of voice output. Note, however, that the questioner and the presentation target person to whom the answer is to be presented may be different and that information may be presented in another form. Assume, for example, that the questioner and the presentation target person to whom the answer is to be presented each possesses a terminal apparatus which has an information display function. In this case, by displaying, on the above terminal apparatus, at least one selected from the group consisting of text and an image, the presentation section 106A may present information to the questioner and/or the presentation target person to whom the answer is to be presented.

As described above, the information processing apparatus 1A includes: the query generation section 101A that uses the generation model 2A, which has been generated by being trained by machine learning so as to be able to generate a search query that is in accordance with an input question, to generate a search query that is for retrieving information related to a target question to which an answer is to be generated; and the answer generation section 102A that uses information detected by search with use of the search query, which is generated by the query generation section 101A, to generate the answer to the target question. Thus, as in the case of the information processing apparatus 1, the information processing apparatus 1A brings about an effect of making it possible to improve accuracy of an answer to a question.

The information processing apparatus 1A further includes the acceptance section 103A that accepts input of a question and the presentation section 106A that presents the answer, which is generated by the answer generation section 102A, to a presentation target person to whom the answer is to be presented, and the query generation section 101A uses, as the target question, the question, which has been accepted by the acceptance section 103A, to generate the search query. Thus, the information processing apparatus 1A brings about not only the effect brought about by the information processing apparatus 1 but also an effect of making it possible to use a single information processing apparatus 1A to carry out a process from acceptance of input of a question to presentation of an answer.

### (Generation of Prompt)

FIG. 5 is a diagram showing an example template that is used to generate a prompt. A template t1 illustrated in FIG. 5 is a template that is used to generate a prompt for generation of a search query.

The template t1 includes the following sentence that instructs generation of a search query: “On the basis of an inquiry from a customer, please create a search query for carrying out search from a target document.” Note that the “target document” in this sentence refers to a document stored in the DB 4A. The template t1 also includes an input field “Inquiry: {question}” corresponding to “the inquiry from the customer” in the above sentence. By entering a target question into a {question} part, the query generation section 101A can generate a prompt that instructs generation of a search query which is based on the target question.

The template t1 also includes the following sentence that instructs generation of the search query with reference to examples described in the template t1: “However, please create the search query with reference to the following examples.” In the template t1, two examples, i.e., an example 1 and an example 2 are described. In each of these examples, a sentence of inquiry (i.e., a question sentence) and a search query corresponding thereto are associated with each other. As described above, a method for causing a prompt to include a plurality of specific examples of input and output and causing the query generation section 101A to generate output with reference to those specific examples is called few-shot learning. Further, this method in which a single example is included in the prompt is called one-shot learning. Although it is not essential to apply few-shot learning or one-shot learning, few-shot learning and one-shot learning are effective for generation of a search query that is in accordance with an intention.

A template t2 illustrated in FIG. 5 is a template that is used to generate a prompt for generation of an answer to a target question or an alternative question. The template t2 includes the following sentence that instructs generation of an answer: “Please answer an inquiry from a customer on the basis of a search result from a target document.” The template t2 also includes an input field “Inquiry: {question}” corresponding to “the inquiry from the customer” in the above sentence and an input field “Search result: {search results}” corresponding to the “search result”. By entering a target question or an alternative question into the {question} part and entering a search result from the search section 105A into a {search results} part, the answer generation section 102A can generate a prompt that instructs generation of an answer to the target question or the alternative question.

The template t2 also includes the following sentence: “You are a person in charge of a product XXX.” This indicates the constraint that an answer is to be generated in the capacity of the person in charge of the product XXX. As described above, the answer generation section 102A may use a prompt including a constraint, condition, or the like under which the answer i generated. This makes it possible to generate the answer that satisfies the constraint or condition. Note that a prompt for generating a search query may also include a constraint or condition. Note also that few-shot learning, one-shot learning, or the like may be applied also to a prompt for generating an answer.

### (Use of Relevant Information)

An optimum answer can vary depending on not only content of a target question per se but also, for example, a questioner who asks the target question, and a presentation target person to whom the answer to the target question is to be presented. For example, in a case where the presentation target person has expert knowledge, it is considered preferable to present a specific answer with use of a technical term. In contrast, in the case where the presentation target person does not have expert knowledge, it is considered preferable to present a simple answer without use of any technical term.

Thus, the query generation section 101A may (i) input, into the generation model 2A, relevant information related to at least one selected from the group consisting of a target question, a questioner who asks the target question, and a presentation target person to whom the answer to the target question is to be presented, and (ii) cause the generation model 2A to generate a search query that is in accordance with the relevant information. This brings about not only the effect brought about by the information processing apparatus 1 but also an effect of making it possible to further improve accuracy of an answer to be generated.

Examples of the relevant information related to the target question: include language used and expressive features (such as a dialect, the end of a word, use of language, and a speech style). Such relevant information can be acquired by using a language model such as the generation model 2A to analyze the target question. Further, information (e.g., a pitch, a tone, a tempo, etc. of voice) obtained by analyzing voice data can also be used as the relevant information.

Examples of the relevant information related to the questioner who asks the target question include age, gender, occupation, a place of residence, a hometown, language used, and a knowledge level of the questioner, a question input by the questioner in the past, and an answer generated to the question. Further, information similar to these pieces of information can be used as the relevant information related to the presentation target person to whom the answer to the target question is to be presented. Such information may be input by the questioner or the like at the time at which the questioner asks the question, may be registered in advance in the response system 100A, or may be generated by analyzing behavior of the questioner or the presentation target person to whom the answer is to be presented.

A plurality of databases to be searched may be prepared. In this case, data that is in accordance with at least one selected from the group consisting of the target question, the questioner who asks the target question, and the presentation target person to whom the answer to the target question is to be presented is stored in each of the databases. The answer generation section 102A generates the answer with use of information detected by search of a database that is among a plurality of databases and that is in accordance with at least one selected from the group consisting of the target question, the questioner who asks the target question, and the presentation target person to whom the answer to the target question is to be presented. Such a configuration also brings about an effect of making it possible to further improve accuracy of an answer to be generated.

For example, a document chunk generated from a product manual in which a technical term is used to specifically describe a product may be stored in a first database for the questioner or the presentation target person who has expert knowledge. Further, a document chunk generated from a product manual in which simple language is used to describe a product may be stored in a second database.

In this case, the search section 105A may determine, in accordance with at least one selected from the group consisting of the target question, the questioner who asks the target question, and the presentation target person to whom the answer to the target question is to be presented, whether the first database or the second database is to be searched. For example, in a case where the target question includes a technical term, the search section 105A may use the first database as a database to be searched. In a case where the target question does not include any technical term, the search section 105A may use the second database as the database to be searched. Alternatively, for example, in a case where the questioner or the presentation target person has a high knowledge level with respect to the product, the search section 105A may use the first database as the database to be searched. In a case where the questioner or the presentation target person has a low knowledge level with respect to the product, the search section 105A may use the second database as the database to be searched.

A plurality of generation models 2A that are caused to generate the search query may be prepared in accordance with at least one selected from the group consisting of the target question, the questioner who asks the target question, and the presentation target person to whom the answer to the target question is to be presented. In this case, the query generation section 101A generates the search query with use of a generation model 2A that is among the plurality of generation models 2A and that is in accordance with at least one selected from the group consisting of the target question, the questioner who asks the target question, and the presentation target person to whom the answer to the target question is to be presented. Such a configuration also brings about an effect of making it possible to further improve accuracy of an answer to be generated.

For example, a first generation model for generation of a search query from a target question in standard language, and a second generation model for generation of a search query from a target question in a specific dialect may be prepared in advance. Note that the second generation model can be generated by machine learning with use of training data in which a search query corresponding to a question in the specific dialect is associated with the question. In this case, the query generation section 101A need only determine whether the target question is described in the standard language or described in the specific dialect. The query generation section 101A which has determined that the target question is described in the standard language may use the first generation model to generate the search query. The query generation section 101A which has determined that the target question is described in the specific dialect may use the second generation model to generate the search query.

### (Flow of Process: From Acceptance of Question to Presentation of Answer)

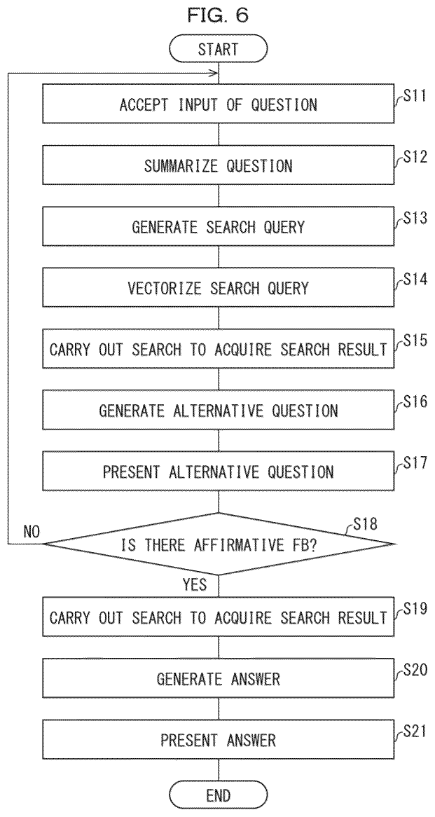

A flow of a process carried out by the information processing apparatus 1A will be described below with reference to FIG. 6. FIG. 6 is a flowchart showing an example process carried out by the information processing apparatus 1A. The flowchart of FIG. 6 includes steps of an answer generation method in accordance with the present example embodiment. Note that the following description will discuss an example in which a question by telephone from the user U illustrated in FIG. 3 has been accepted.

In S11, the acceptance section 103A accepts input of a question from the user U, who is a questioner. Voice data of a question uttered by the user U is transmitted to the information processing apparatus 1A via the telephone switching apparatus. Thus, the acceptance section 103A acquires the voice data, transmits the acquired voice data to the voice recognition apparatus 5A to convert the voice data into text data, and acquires the question that has been converted into text data.

It is also assumed that the user U makes a phone call to consult the operator Op. Thus, in a case where the phone call is received from the user U, an interactive voice response system may be used to inquire of the user U whether the user U wishes handling by the operator or whether the user U is not picky about handling by the operator. Then, the question from the user may be transferred to the information processing apparatus 1A in a case where the user U inputs an answer indicating that the user U is not picky about handling by the operator.

Further, content of the question may be narrowed down before the user U is prompted to input the question. For example, the interactive voice response system may be used to output a voice that requests the user U to select, from among a plurality of options, what the question is related to, and allow the user U to select an option by operating a push button of a telephone. Alternatively, for example, the user may be allowed to enter, for example, the number of a store, to which an inquiry is to be addressed, by operating a push button of a telephone. This makes it possible to further improve accuracy of an answer by narrowing down items that the user U wishes to ask.

It is also considered that the user U gives utterance (e.g., a greeting, etc.) different from a question. Thus, the answer generation section 102A may determine whether input by the user U is a question, and S12 and subsequent steps may be carried out in a case where the answer generation section 102A determines that the input by the user U is a question. In this case, if the answer generation section 102A determines that the input by the user U is not a question, the answer generation section 102A may input text of content of the utterance given by the user into the generation model 2A to generate an answer (such as a greeting in the case of an answer to a greeting), and may instruct the presentation section 106A to present the answer to the user U.

Note here that S12 to S18 in FIG. 6 are steps for generating an alternative question. In a case where it is not necessary to generate the alternative question, after S11, the query generation section 101A uses, as a target question, the question, which has been accepted in S11, to generate a search query (a query generation process). Next, the search section 105A inputs the search query into the vector generation model 3A to generate a feature vector, uses the generated feature vector to carry out search of the DB 4A, and acquires a search result. Then, the answer generation section 102A uses information detected by the search to generate an answer to the target question (an answer generation process).

In S12, the question generation section 104A generates a summary of the question, the input of which has been accepted in S11. For example, the question generation section 104A may generate the summary by generating a prompt that includes the question, the input of which has been accepted in S11, and that instructs generation of a summary of the question, and inputting the generated prompt into a language model such as the generation model 2A.

In S13 (the query generation process), the query generation section 101A uses the generation model 2A to generate a search query for retrieving information related to the summary generated in S12. As described above, by generating a search query for retrieving information not related to an input question itself but related to a summary of the input question, it is also possible to detect information related to the input question. The prompt used in S13 can be similar to a prompt in a case where a search query for retrieving information related to the target question is generated. For example, the query generation section 101A may generate the search query with use of a prompt that has been generated by entering the summary generated in S12 into the {question} part of the template t1 illustrated in FIG. 5.

In S14, the search section 105A generates a feature vector by inputting, into the vector generation model 3A, the search query generated in S13. Next, in S15, the search section 105A uses the feature vector generated in S14 to carry out search of the DB 4A and acquires a search result. More specifically, the search section 105A acquires, as the search result, data which is among data stored in the DB 4A and with which a feature vector having a high degree of similarity to a feature vector used for the search is associated.

In S16, the question generation section 104A uses the summary obtained in S12 to generate the alternative question. Alternatively, the question generation section 104A may use not only the above summary but also the search result acquired in S15. For example, the question generation section 104A may generate the alternative question by generating a prompt that includes the summary obtained in S12 and the search result acquired in S15 and that instructs generation of a question which is in accordance with content of the summary and the search result, and inputting the generated prompt into a language model such as the generation model 2A.

In S17, the presentation section 106A presents, to the user U, the alternative question generated in S16. For example, the presentation section 106A may use the interactive voice response system to convert, into voice, text generated by entering the alternative question into a {question} part of a template “Your question is {question}, isn't it?”, and may present, to the user U, the text, which has been converted into voice.

In S18, the acceptance section 103A determines whether feedback that is affirmative in content has been given to the alternative question presented in S17. In a case where a result of determination is YES in S18, the process proceeds to S19. In a case where the result of determination is NO in S18, the process returns to S11. In S11, to which the process has transitioned from S18, the acceptance section 103A accepts input of a new question by, for example, causing the interactive voice response system to output a voice that promotes a question to be input again (for example, a message such as “Sorry. Please input your question again.”).

Note that in S18, feedback may be input by voice or may be input by, for example, operating a push button of a telephone. In the former case, the acceptance section 103A may input, into a language model such as the generation model 2A, text into which input voice has been converted by the voice recognition apparatus 5A, and cause the language model to determine whether the text is affirmative in content.

Next, in S19, the search section 105A uses the feature vector generated in S14 to carry out search of the DB 4A and acquires a search result. In S19, as in the case of S15, the search section 105A acquires, as the search result, data which is among data stored in the DB 4A and with which a feature vector having a high degree of similarity to a feature vector used for the search is associated.

In S20 (the answer generation process), the answer generation section 102A uses information detected by search with use of the search query generated in S13, i.e., the search result obtained in S19 to generate the answer to the target question. More specifically, the answer generation section 102A uses the search result in S19 and the target question to generate a prompt that instructs generation of an answer to the target question, and generates the answer by inputting the generated prompt into the generation model 2A. For example, the answer generation section 102A may generate the answer with use of a prompt that has been generated by entering the target question into the {question} part of the template t2 illustrated in FIG. 5, and entering the search result into the {search results} part.

In S21, the presentation section 106A presents, to the user U, the answer generated in S20. More specifically, the presentation section 106A uses the interactive voice response system to convert, into voice, the answer generated in S20, and presents, to the user U, the answer, which has been converted into voice. This ends the process of FIG. 6.

Note that, after S21, the acceptance section 103A may accept feedback on the presented answer by, for example, causing the interactive voice response system to output a voice that promotes input of whether the user U is satisfied with the presented answer. The acceptance section 103A may also accept an additional question by, for example, causing the interactive voice response system to output a voice that promotes input of a possible additional question. In a case where the acceptance section 103A has accepted the additional question, the process returns to the step S12.

Assume here that the additional question is a question related to a previous question. In this case, in generation of an answer to the additional question, it is preferable to also input the previous question and an answer thereto, i.e., a history of handling, into a prompt to generate an answer that considers the previous question and the answer thereto. This makes it possible to generate a highly accurate answer that is based on details of dialogue. In contrast, in a case where the additional question is not the question related to the previous question, it is preferable to generate the answer without considering a history of handling of the previous question.

Note that a service which uses the information processing apparatus 1A to present an answer may be provided to only a predetermined target person (for example, a contractor of the service or a customer of the contractor). In this case, user authentication may be carried out before the step S11 is carried out, and S11 and subsequent steps may be carried out on condition that user authentication has been successful. A user authentication method is not particularly limited. For example, the acceptance section 103A may determine whether a predetermined passphrase has been input, and the step S11 may be carried out in a case where the acceptance section 103A determines that the passphrase has been input. The passphrase, which can be input by voice, is preferable in that authentication can be carried out smoothly without any need to carry out character input or the like.

### (Switching to Handling by Operator)

The switching section 107A switches handling of a questioner to handling by an operator. More specifically, in a case where a predetermined switching condition is satisfied, the switching section 107A carries out switching above by controlling the telephone switching apparatus illustrated in FIG. 3 so as to place the questioner and the operator Op in a talk state.

The above switching condition need only be determined as appropriate. For example, the switching condition may be that search with use of a search query has been unsuccessful a predetermined number of times in succession. In this case, the switching section 107A switches handling of the questioner to handling by the operator in a case where search by the search section 105A has been unsuccessful a predetermined number of times in succession. This brings about not only the effect brought about by the information processing apparatus 1 but also an effect of making it possible to carry out an appropriate response by the operator in a situation where it is difficult to generate an answer that is based on a search result.

Note that conditions for success and failure in search need only be determined in advance. For example, it may be determined that search has been unsuccessful in a case where data with which a feature vector whose degree of similarity to a feature vector of the search query is not less than a predetermined threshold is associated is not stored in the DB 4A.

Further, for example, in a case where feedback that is given to the answer, which has been presented in S21 in FIG. 6, by a presentation target person to which the answer is to be presented is negative in content, the switching section 107A may switch handling of the presentation target person to handling by the operator. This makes it possible to prevent a talk with the presentation target person from ending while no satisfying answer is presented. The switching section 107A preferably switches to handling by the operator also in a case where the questioner makes utterance or operation input that requests switching to handling by the operator.

Note here that, in a case where handling by the information processing apparatus 1A is switched to handling by the operator, the presentation section 106A may present, to the operator, each question that has been input into the information processing apparatus 1A before such switching. This makes it possible to make the operator understand what the questioner wishes to ask, and cause the operator to handle the questioner.

The presentation section 106A may also present a summary of each question that has been input before switching. This makes it possible to make the operator understand in a short period of time what the questioner wishes to ask, and cause the operator to handle the questioner smoothly. Note that the summary need only be generated by the question generation section 104A as in the case of S12 in FIG. 6.

### [Variation]

The second example embodiment has discussed an example in which the response system 100A makes an answer, by voice, to a question that is input by voice. Note, however, that the response system 100A can also make an answer, by text, to a question that is input by text. This case makes a process carried out by the information processing apparatus 1A similar in content to that in the second example embodiment merely by making the voice recognition apparatus 5A and the interactive voice response system unnecessary.

### Software Implementation Example

Some or all of the functions of the information processing apparatuses 1 and 1A can be realized by hardware such as an integrated circuit (IC chip), or can be realized by software.

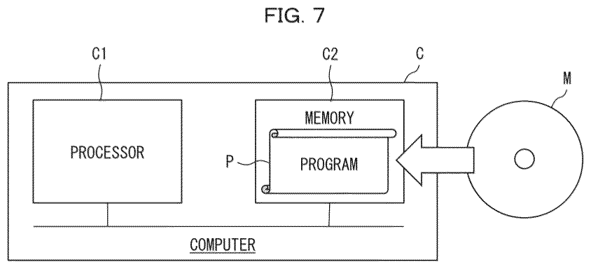

In the latter case, the information processing apparatuses 1 and 1A are each realized by, for example, a computer that executes instructions of a program that is software realizing the foregoing functions. FIG. 7 illustrates an example of such a computer (hereinafter, referred to as “computer C”). FIG. 7 is a block diagram illustrating a hardware configuration of the computer C which functions as the information processing apparatus 1 or 1A.

The computer C includes at least one processor C1 and at least one memory C2. In the memory C2, a program (answer generation program) P for causing the computer C to operate as the information processing apparatus 1 or 1A is recorded. In the computer C, the functions of the information processing apparatus 1 or 1A are realized by the processor C1 reading the program P from the memory C2 and executing the program P.

The processor C1 can be, for example, a central processing unit (CPU), a graphic processing unit (GPU), digital signal processor (DSP), a micro processing unit (MPU), a floating point number processing unit (FPU), a physics processing unit (PPU), a tensor processing unit (TPU), a quantum processor, a microcontroller, or a combination of these. The memory C2 can be, for example, a flash memory, a hard disk drive (HDD), a solid state drive (SSD), or a combination of these.

Note that the computer C may further include a random access memory (RAM) in which the program P is loaded during execution of the program P and/or in which various kinds of data are temporarily stored. The computer C may further include a communication interface via which the computer C transmits and receives data to and from another apparatus. The computer C may further include an input/output interface via which the computer C is connected to an input/output apparatus(es) such as a keyboard, a mouse, a display, and/or a printer.

The program P can be stored in a non-transitory tangible recording medium M which is readable by the computer C. The recording medium M can be, for example, a tape, a disk, a card, a semiconductor memory, or a programmable logic circuit. The computer C can acquire the program P via the recording medium M. The program P can be transmitted via a transmission medium. The transmission medium a can be, for example, communications network or a broadcast wave. The computer C can acquire the program P also via the transmission medium.

The foregoing functions of the information processing apparatuses 1 and 1A may be realized by a single processor provided in a single computer, may be realized by cooperation by a plurality of processors provided in a single computer, or may be realized by cooperation by a plurality of processors provided in a respective plurality of computers. A program for causing the information processing apparatus 1 or 1A to realize the foregoing functions may be stored in a single memory provided in a single computer, may be stored dispersedly in a plurality of memories provided in a single computer, or may be stored dispersedly in a plurality of memories provided in a respective plurality of computers.

### [Additional Remark]

The present disclosure includes techniques described in supplementary notes below. Note, however, that the present invention is not limited to the techniques described in the supplementary notes below, but may be altered in various ways by a skilled person within the scope of the claims.

### (Supplementary Note A1)

An information processing apparatus including: a query generation means for using at least one generation model, which has been generated by being trained by machine learning so as to be able to generate a search query that is in accordance with an input question, to generate a search query that is for retrieving information related to a target question to which an answer is to be generated; and an answer generation means for using information detected by search with use of the search query to generate the answer to the target question.

### (Supplementary Note A2)

The information processing apparatus described in supplementary note A1, further including an acceptance means for accepting input of a question, and a presentation means for presenting the answer, which is generated by the answer generation means, to a presentation target person to whom the answer is to be presented, the query generation means using, as the target question, the question, which has been accepted by acceptance means, to generate the search query.

### (Supplementary Note A3)

The information processing apparatus described in supplementary note A1 or A2, wherein the at least one generation model is a language model that has been generated by machine learning of natural language, and the answer generation means uses the at least one generation model to generate the answer to the target question.

### (Supplementary Note A4)

The information processing apparatus described in any one of supplementary notes A1 to A3, wherein the information processing apparatus (i) inputs, into the at least one generation model, relevant information related to at least one selected from the group consisting of the target question, a questioner who asks the target question, and a presentation target person to whom the answer to the target question is to be presented, and (ii) causes the at least one generation model to generate the search query that is in accordance with the relevant information.

### (Supplementary Note A5)

The information processing apparatus described in any one of supplementary notes A1 to A4, wherein the answer generation means generates the answer with use of information detected by search of a database that is among a plurality of databases and that is in accordance with at least one selected from the group consisting of the target question, a questioner who asks the target question, and a presentation target person to whom the answer to the target question is to be presented.

### (Supplementary Note A6)

The information processing apparatus described in any one of supplementary notes A1 to A5, wherein the query generation means generates the search query with use of a generation model that is among a plurality of generation models which the at least one generation model comprises and that is in accordance with at least one selected from the group consisting of the target question, a questioner who asks the target question, and a presentation target person to whom the answer to the target question is to be presented.

### (Supplementary Note A7)

The information processing apparatus described in any one of supplementary notes A1 to A6, further including a question generation means for generating an alternative question by paraphrasing a question that has been input by a questioner who asks the target question, a presentation means for presenting the alternative question to the questioner, and an acceptance means for accepting feedback given by the questioner to the presented alternative question, in a case where the feedback given to the alternative question is affirmative in content, the answer generation means generating the answer with use of information detected by search with use of the search query that is for retrieving information related to the alternative question.

### (Supplementary Note A8)

The information processing apparatus described in any one of supplementary notes A1 to A7, further including a switching means for, in a case where search with use of the search query has been unsuccessful a predetermined number of times in succession, switching handling of a questioner who asks the target question to handling by an operator.

### (Supplementary Note B1)

An answer generation method including: a query generation process for using at least one generation model, which has been generated by being trained by machine learning so as to be able to generate a search query that is in accordance with an input question, to generate a search query that is for retrieving information related to a target question to which an answer is to be generated; and an answer generation process for using information detected by search with use of the search query to generate the answer to the target question, the query generation step and the answer generation step each being carried out by at least one processor.

### (Supplementary Note B2)

The answer generation method described in supplementary note B1, further including an acceptance process for accepting input of a question, the acceptance process being carried out by the at least one processor, and a presentation process for presenting the answer, which has been generated in the answer generation process, to a presentation target person to whom the answer is to be presented, the presentation process being carried out by the at least one processor, in the query generation process, the at least one processor using, as the target question, the question, which has been accepted in the acceptance process, to generate the search query.

### (Supplementary Note B3)

The answer generation method described in supplementary note B1 or B2, wherein the at least one generation model is a language model that has been generated by machine learning of natural language, and in the answer generation process, the at t least one processor uses the at least one generation model to generate the answer to the target question.

### (Supplementary Note B4)

The answer generation method described in any one of supplementary notes B1 to B3, wherein in the query generation process, the at least one processor (i) inputs, into the at least one generation model, relevant information related to at least one selected from the group consisting of the target question, a questioner who asks the target question, and a presentation target person to whom the answer to the target question is to be presented, and (ii) causes the at least one generation model to generate the search query that is in accordance with the relevant information.

### (Supplementary Note B5)

The answer generation method described in any one of supplementary notes B1 to B4, wherein in the answer generation process, the at least one processor generates the answer with use of information detected by search of a database that is among a plurality of databases and that is in accordance with at least one selected from the group consisting of the target question, a questioner who asks the target question, and a presentation target person to whom the answer to the target question is to be presented.

### (Supplementary Note B6)

The answer generation method described in any one of supplementary notes B1 to B5, wherein in the query generation process, the at least one processor generates the search query with use of a generation model that is among a plurality of generation models which the at least one generation model comprises and that is in accordance with at least one selected from the group consisting of the target question, a questioner who asks the target question, and a presentation target person to whom the answer to the target question is to be presented.

### (Supplementary Note B7)

The answer generation method described in any one of supplementary notes B1 to B6, further including a question generation process for generating an alternative question by paraphrasing a question that has been input by a questioner who asks the target question, the question generation process being carried out by the at least one processor, a presentation process for presenting the alternative question to the questioner, the presentation process being carried out by the at least one processor, and an acceptance process for accepting feedback given by the questioner to the presented alternative question, the acceptance process being carried out by the at least one processor, in a case where the feedback given to the alternative question is affirmative in content, in the answer generation process, the at least one processor generating the answer with use of information detected by search with use of the search query that is for retrieving information related to the alternative question.

### (Supplementary Note B8)

The answer generation method described in any one of supplementary notes B1 to B7, further including a switching process for, in a case where search with use of the search query has been unsuccessful a predetermined number of times in succession, switching handling of a questioner who asks the target question to handling by an operator, the switching process being carried out by the at least one processor.

### (Supplementary Note C1)

An answer generation program for causing a computer to function as: a query generation means for using at least one generation model, which has been generated by being trained by machine learning so as to be able to generate a search query that is in accordance with an input question, to generate a search query that is for retrieving information related to a target question to which an answer is to be generated; and an answer generation means for using information detected by search with use of the search query to generate the answer to the target question.

### (Supplementary Note C2)

The answer generation program described in supplementary note C1, wherein the computer is caused to function as an acceptance means for accepting input of a question, and a presentation means for presenting the answer, which is generated by the answer generation means, to a presentation target person to whom the answer is to be presented, and the query generation means uses, as the target question, the question, which has been accepted by acceptance process, to generate the search query.

### (Supplementary Note C3)

The answer generation program described in supplementary note C1 or C2, wherein the at least one generation model is a language model that has been generated by machine learning of natural language, and the answer generation means uses the at least one generation model to generate the answer to the target question.

### (Supplementary Note C4)

The answer generation program described in any one of supplementary notes C1 to C3, wherein the query generation means (i) inputs, into the at least one generation model, relevant information related to at least one selected from the group consisting of the target question, a questioner who asks the target question, and a presentation target person to whom the answer to the target question is to be presented, and (ii) causes the at least one generation model to generate the search query that is in accordance with the relevant information.

### (Supplementary Note C5)

The answer generation program described in any one of supplementary notes C1 to C4, wherein the answer generation means s generates the answer with use of information detected by search of a database that is among a plurality of databases and that is in accordance with at least one selected from the group consisting of the target question, a questioner who asks the target question, and a presentation target person to whom the answer to the target question is to be presented.

### (Supplementary Note C6)

The answer generation program described in any one of supplementary notes C1 to C5, wherein the query generation means generates the search query with use of a generation model that is among a plurality of generation models which the at least one generation model comprises and that is in accordance with at least one selected from the group consisting of the target question, a questioner who asks the target question, and a presentation target person to whom the answer to the target question is to be presented.

### (Supplementary Note C7)

The answer generation program described in any one of supplementary notes C1 to C6, wherein the computer is caused to function as a question generation means for generating an alternative question by paraphrasing a question that has been input by a questioner who asks the target question, a presentation means for presenting the alternative question to the questioner, and an acceptance means for accepting feedback given by the questioner to the presented alternative question, and in a case where the feedback given to the alternative question is affirmative in content, the answer generation means generates the answer with use of information detected by search with use of the search query that is for retrieving information related to the alternative question.

### (Supplementary Note C8)

The answer generation program described in any one of supplementary notes C1 to C7, wherein the computer is caused to function as a switching means for, in a case where search with use of the search query has been unsuccessful a predetermined number of times in succession, switching handling of a questioner who asks the target question to handling by an operator.

### (Supplementary Note D1)

An information processing apparatus including at least one processor, the at least one processor carrying out: a query generation process for using at least one generation model, which has been generated by being trained by machine learning so as to be able to generate a search query that is in accordance with an input question, to generate a search query that is for retrieving information related to a target question to which an answer is to be generated; and an answer generation process for using information detected by search with use of the search query to generate the answer to the target question.

Note that the information processing apparatus may further include a memory. The memory may store a program for causing the at least one processor to carry out each of the processes.

### (Supplementary Note D2)

The information processing apparatus described in supplementary note D1, wherein the at least one processor carries out an acceptance process for accepting input of a question, and a presentation process for presenting the answer, which has been generated in the answer generation process, to a presentation target person to whom the answer is to be presented, and in the query generation process, the at least one processor uses, as the target question, the question, which has been accepted in the acceptance process, to generate the search query.

### (Supplementary Note D3)

The information processing apparatus described in supplementary note D1 or D2, wherein the at least one generation model is a language model that has been generated by machine learning of natural language, and in the answer generation process, the at least one processor uses the at least one generation model to generate the answer to the target question.

### (Supplementary Note D4)

The information processing apparatus described in any one of supplementary notes D1 to D3, wherein in the query generation process, the at least one processor (i) inputs, into the at least one generation model, relevant information related to at least one selected from the group consisting of the target question, a questioner who asks the target question, and a presentation target person to whom the answer to the target question is to be presented, and (ii) causes the at least one generation model to generate the search query that is in accordance with the relevant information.

### (Supplementary Note D5)

The information processing apparatus described in any one of supplementary notes D1 to D4, wherein in the answer generation process, the at least one processor generates the answer with use of information detected by search of a database that is among a plurality of databases and that is in accordance with at least one selected from the group consisting of the target question, a questioner who asks the target question, and a presentation target person to whom the answer to the target question is to be presented.

### (Supplementary Note D6)

The information processing apparatus described in any one of supplementary notes D1 to D5, wherein in the query generation process, the at least one processor generates the search query with use of a generation model that is among a plurality of generation models which the at least one generation model comprises and that is in accordance with at least one selected from the group consisting of the target question, a questioner who asks the target question, and a presentation target person to whom the answer to the target question is to be presented.

### (Supplementary Note D7)

The information processing apparatus described in any one of supplementary notes D1 to D6, wherein the at least one processor carries out a question generation process for generating an alternative question by paraphrasing a question that has been input by a questioner who asks the target question, a presentation process for presenting the alternative question to the questioner, and an acceptance process for accepting feedback given by the questioner to the presented alternative question, and in a case where the feedback given to the alternative question is affirmative in content, in the answer generation process, the at least one processor generates the answer with use of information detected by search with use of the search query that is for retrieving information related to the alternative question.

### (Supplementary Note D8)

The information processing apparatus described in any one of supplementary notes D1 to D7, wherein the at least one processor carries out a switching process for, in a case where search with use of the search query has been unsuccessful a predetermined number of times in succession, switching handling of a questioner who asks the target question to handling by an operator.

### (Supplementary Note E)

A non-transitory recording medium recording therein an answer generation program for causing a computer to carry out: a query generation process for using at least one generation model, which has been generated by being trained by machine learning so as to be able to generate a search query that is in accordance with an input question, to generate a search query that is for retrieving information related to a target question to which an answer is to be generated; and an answer generation process for using information detected by search with use of the search query to generate the answer to the target question.

### REFERENCE SIGNS LIST

1 Information processing apparatus
101 Query generation section (query generation means)
102 Answer generation section (answer generation means)
1A Information processing apparatus
101A Query generation section (query generation means)
102A Answer generation section (answer generation means)
103A Acceptance section (acceptance means)
104A Question generation section (question generation means)
106A Presentation section (presentation means)
107A Switching section (switching means)
2A Generation model
4A Database (DB)

1. An information processing apparatus comprising at least one processor, the at least one processor carrying out:
a query generation process for using at least one generation model, which has been generated by being trained by machine learning so as to be able to generate a search query that is in accordance with an input question, to generate a search query that is for retrieving information related to a target question to which an answer is to be generated; and
an answer generation process for using information detected by search with use of the search query to generate the answer to the target question.

2. The information processing apparatus according to claim 1, wherein
the at least one processor carries out
an acceptance process for accepting input of a question, and
a presentation process for presenting the answer, which has been generated in the answer generation process, to a presentation target person to whom the answer is to be presented, and
in the query generation process, the at least one processor uses, as the target question, the question, which has been accepted in the acceptance process, to generate the search query.

3. The information processing apparatus according to claim 1, wherein
the at least one generation model is a language model that has been generated by machine learning of natural language, and
in the answer generation process, the at least one processor uses the at least one generation model to generate the answer to the target question.

4. The information processing apparatus according to claim 1, wherein
in the query generation process, the at least one processor (i) inputs, into the at least one generation model, relevant information related to at least one selected from the group consisting of the target question, a questioner who asks the target question, and a presentation target person to whom the answer to the target question is to be presented, and (ii) causes the at least one generation model to generate the search query that is in accordance with the relevant information.

5. The information processing apparatus according to claim 1, wherein
in the answer generation process, the at least one processor generates the answer with use of information detected by search of a database that is among a plurality of databases and that is in accordance with at least one selected from the group consisting of the target question, a questioner who asks the target question, and a presentation target person to whom the answer to the target question is to be presented.

6. The information processing apparatus according to claim 1, wherein
in the query generation process, the at least one processor generates the search query with use of a generation model that is among a plurality of generation models which the at least one generation model comprises and that is in accordance with at least one selected from the group consisting of the target question, a questioner who asks the target question, and a presentation target person to whom the answer to the target question is to be presented.

7. The information processing apparatus according to claim 1, wherein
the at least one processor carries out
a question generation process for generating an alternative question by paraphrasing a question that has been input by a questioner who asks the target question,
a presentation process for presenting the alternative question to the questioner, and
an acceptance process for accepting feedback given by the questioner to the presented alternative question, and
in the answer generation process, in a case where the feedback given to the alternative question is affirmative in content, the at least one processor generates the answer with use of information detected by search with use of the search query that is for retrieving information related to the alternative question.

8. The information processing apparatus according to claim 1, wherein the at least one processor carries out a switching process for, in a case where search with use of the search query has been unsuccessful a predetermined number of times in succession, switching handling of a questioner who asks the target question to handling by an operator.

9. An answer generation method comprising:
a query generation process for using at least one generation model, which has been generated by being trained by machine learning so as to be able to generate a search query that is in accordance with an input question, to generate a search query that is for retrieving information related to a target question to which an answer is to be generated; and
an answer generation process for using information detected by search with use of the search query to generate the answer to the target question,
the query generation process and the answer generation process each being carried out by at least one processor.

10. A non-transitory computer-readable recording medium recording therein an answer generation program for causing a computer to carry out:
a query generation process for using at least one generation model, which has been generated by being trained by machine learning so as to be able to generate a search query that is in accordance with an input question, to generate a search query that is for retrieving information related to a target question to which an answer is to be generated; and
an answer generation process for using information detected by search with use of the search query to generate the answer to the target question.
